(19) United States
(12) Patent Application Publication
(10) Pub. No.: US 2023/0317341 A1
(43) Pub. Date: Oct. 5, 2023

(54) COIL COMPONENT

(71) Applicant: TAIYO YUDEN CO., LTD., Tokyo (JP)

(72) Inventor: Kazuki MISAWA, Tokyo (JP)

(21) Appl. No.: 18/185,801

(22) Filed: Mar. 17, 2023

(30) Foreign Application Priority Data
Mar. 31, 2022 (JP) 2022-060316

(51) Int. Cl. H01F 17/00; H01F 27/29; H01F 27/255

(52) U.S. Cl. CPC H01F 17/0013; H01F 27/292; H01F 27/255

(57) ABSTRACT

One object of the disclosure is to configure a coil component to inhibit ion migration of metals contained in a coil conductor not coated with a glass layer or a resin layer. A coil component includes a base body and a coil conductor disposed in the base body and made mainly of copper. A copper oxide film is formed on the surface of the coil conductor. The base body includes a plurality of metal magnetic particles, the plurality of metal magnetic particles containing Fe, Si, and an element A, the element A being at least one selected from the group consisting of Cr and Al. The surface of the metal magnetic particles is coated with an oxide film. In the oxide film, a sum of an atomic percentage of Si and an atomic percentage of the element A is higher than an atomic percentage of Fe.

### CROSS-REFERENCE TO RELATED APPLICATIONS

This application is based on and claims the benefit of priority from Japanese Patent Application Serial No. 2022-060316 (filed on Mar. 31, 2022), the contents of which are hereby incorporated by reference in their entirety.

### TECHNICAL FIELD

The present disclosure relates mainly to a coil component.

### BACKGROUND

Coil components are installed in various electronic devices. For example, coil components are used to eliminate noise in power source lines or signal lines in circuits. A common coil component includes a base body formed of a magnetic material and a coil conductor provided in the base body.

The base body of a coil component is a soft magnetic base body containing a large number of metal magnetic particles made of a soft magnetic material. In the soft magnetic base body, the surfaces of the metal magnetic particles are covered with insulating films, and adjacent metal magnetic particles are bonded to each other via the insulating films. Since the soft magnetic base body is less prone to magnetic saturation than a magnetic base body made of ferrite, the soft magnetic base body is suitable for large-current circuits.

The surface of the coil conductor may be coated with an insulating coating film. For example, the coil component disclosed in Japanese Patent Application Publication No. 2020-191408 includes a coil conductor coated with an insulating glass layer. Also, the coil component disclosed in International Publication No. WO2018/088264 includes a coil conductor coated with a polyimide resin.

Coating the surface of the coil conductor with an insulating coating layer (e.g., the glass layer or polyimide resin layer described above) increases the dielectric strength of the coil component.

In many cases, the coil conductor is composed mainly of silver. Silver is prone to ion migration. A coating layer on the surface of the coil conductor can inhibit ion migration between the coil conductor and other conductors (e.g., external conductors).

The coating layer on the surface of the coil conductor inhibits oxidation of the metallic elements in the coil conductor and inhibits an increase in the DC resistance of the coil conductor.

As described above, there are advantages in having a glass layer or a resin layer on the surface of the coil conductor. On the other hand, an additional step is required during manufacturing to provide a coating layer on the surface of the coil conductor. For example, when the coil component is made by the sheet lamination method, the coil conductor is made by applying a conductive paste to magnetic sheets and heating the conductive paste. In order to provide a coating layer on the surface of the coil conductor made in this manner, it is necessary to further apply a paste for the coating layer after the conductive paste is applied to the magnetic sheets.

On the other hand, when no coating layer is provided on the surface of the coil conductor, the characteristics of the coil component may deteriorate. For example, when no coating layer is provided on the surface of the coil conductor, the ion migration between the coil conductor and the external electrodes is likely to increase.

### SUMMARY

One object of the present disclosure is to overcome or reduce at least a part of the above drawback. In particular, one object of the present invention is to configure a coil component to inhibit ion migration of metals contained in a coil conductor not coated with a glass layer or a resin layer.

Other objects of the disclosure will be made apparent through the entire description in the specification. The inventions recited in the claims may also address any other drawbacks in addition to the above drawback.

A coil component according to one aspect of the invention includes: a base body including a plurality of metal magnetic particles, the plurality of metal magnetic particles containing Fe, Si, and an element A, the element A being at least one selected from the group consisting of Cr and Al, a surface of each of the plurality of metal magnetic particles being covered by an oxide film containing Fe oxide and an oxide of the element A; a coil conductor disposed in the base body and made mainly of copper; and a copper oxide film covering a surface of the coil conductor and made mainly of copper oxide. In one aspect, in the oxide film covering the surface of each of the plurality of metal magnetic particles, a sum of an atomic percentage of Si and an atomic percentage of the element A is higher than an atomic percentage of Fe.

### Advantageous Effects

According to the invention, it is possible to inhibit ion migration of metals contained in a coil conductor without coating the surface of the coil conductor with a glass layer or a resin layer.

### BRIEF DESCRIPTION OF THE DRAWINGS

FIG. 1 is a perspective view of a coil component according to one aspect of the invention.

FIG. 2 is an exploded perspective view of the coil component shown in FIG. 1.

FIG. 3 is a sectional view of the coil component of FIG. 1 along the line I-I.

FIG. 4 is an enlarged schematic sectional view of a region A of FIG. 3.

FIG. 5 is an enlarged schematic sectional view of a region B of FIG. 4.

FIG. 6 is a flowchart showing a method of manufacturing a coil component according to one aspect of the present invention.

FIG. 7 is a graph of TG curves showing the change in weight of acrylic resin, ethylcellulose, and copper heated in the air.

FIG. 8 is a graph of TG curves showing the change in weight of acrylic resin, ethylcellulose, and copper heated in a nitrogen atmosphere.

### DESCRIPTION OF THE PREFERRED EMBODIMENTS

Various embodiments of the present invention will be described hereinafter with reference to the appended drawings. Throughout the drawings, the same components are denoted by the same reference numerals. For convenience of explanation, the drawings are not necessarily drawn to scale. The following embodiments of the present invention do not limit the scope of the claims. The elements included in the following embodiments are not necessarily essential to solve the problem addressed by the invention.

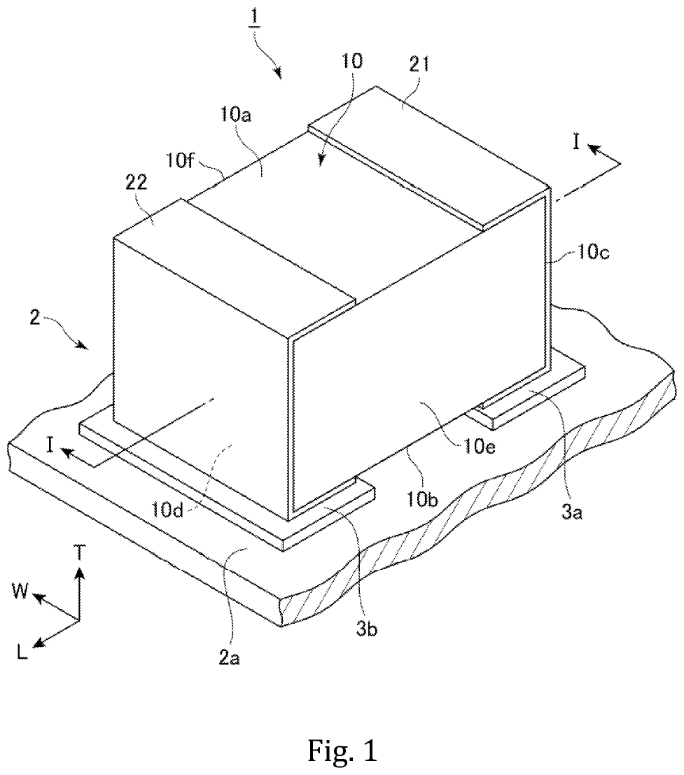

A coil component 1 according to one embodiment of the invention will be hereinafter described with reference to FIGS. 1 to 3. In the illustrated embodiment, the coil component 1 is a laminated inductor. The laminated inductor may be used as a power inductor incorporated into a power supply line or as other various inductors. The invention may be applied to various coil components, in addition to the laminated inductor illustrated in the drawing.

As shown, the coil component 1 includes a base body 10, a coil conductor 25 disposed in the base body 10, an external electrode 21 disposed on a surface of the base body 10, and an external electrode 22 disposed on a surface of the base body 10 at a location spaced apart from the external electrode 21.

The coil component 1 is mounted on a mounting substrate 2a. A circuit board 2 includes the coil component 1 and the mounting substrate 2a on which the coil component 1 is mounted. The mounting substrate 2a has lands 3a and 3b provided thereon. The coil component 1 is mounted on the mounting substrate 2a by bonding the external electrode 21 to the land 3a and bonding the external electrode 22 to the land 3b. The circuit board 2 may include the coil component 1 and various other electronic components.

The circuit board 2 can be installed in various electronic devices. The electronic devices in which the circuit board 2 may be installed include smartphones, tablets, game consoles, servers, electrical components of automobiles, and various other electronic devices. The electronic devices in which the coil component 1 may be installed are not limited to those specified herein.

In one or more embodiments of the invention, the base body 10 has a substantially rectangular parallelepiped shape and is formed from a magnetic material. The base body 10 has a first principal surface 10a, a second principal surface 10b, a first end surface 10c, a second end surface 10d, a first side surface 10e, and a second side surface 10f. These six surfaces define the outer periphery of the base body 10. The first principal surface 10a and the second principal surface 10b are opposed to each other, the first end surface 10c and the second end surface 10d are opposed to each other, and the first side surface 10e and the second side surface 10f are opposed to each other. As shown in FIG. 1, the first principal surface 10a lies on the top side of the base body 10, and therefore, the first principal surface 10a may be herein referred to as “the top surface.” Similarly, the second principal surface 10b may be referred to as “the bottom surface.” The coil component 1 is disposed such that the second principal surface 10b faces the circuit board 2, and therefore, the second principal surface 10b may be herein referred to as a “mounting surface.” The top-bottom direction of the coil component 1 mentioned herein refers to the top-bottom direction in FIG. 1. In this specification, a “length” direction, a “width” direction, and a “height” direction of the coil component 1 correspond to the “L axis” direction, the “W axis” direction, and the “T axis” direction in FIG. 1, respectively, unless otherwise construed from the context. The L axis, the W axis, and the T axis are orthogonal to one another.

In one or more embodiments of the invention, the coil component 1 has a length (the dimension in the direction of the L axis) of 0.2 to 6.0 mm, a width (the dimension in the direction of the W axis) of 0.1 to 4.5 mm, and a thickness (the dimension in the direction of the T axis) of 0.1 to 4.0 mm. These dimensions are mere examples, and the coil component 1 to which the present invention is applicable can have any dimensions that conform to the purport of the present invention. In one or more embodiments, the coil component 1 has a low profile. For example, the coil component 1 has a width larger than the height thereof.

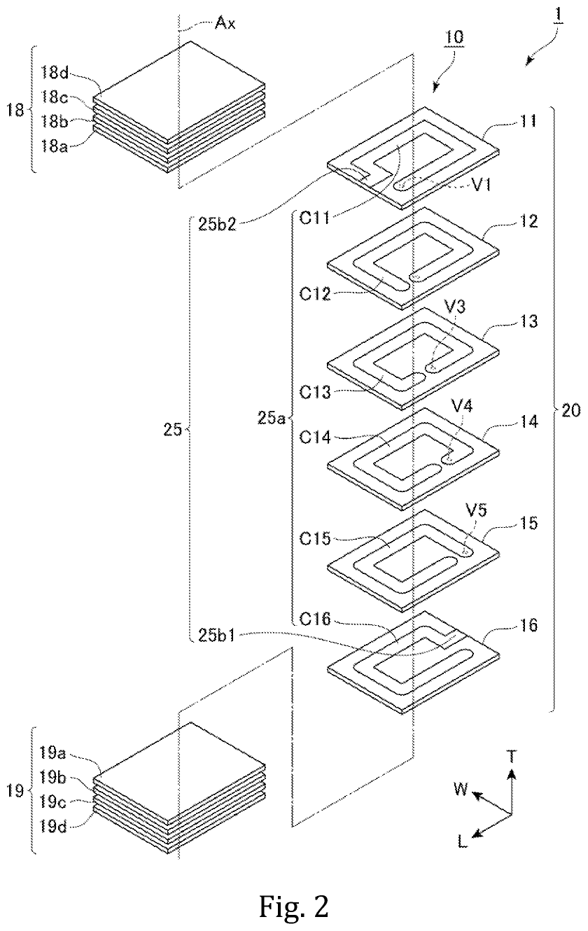

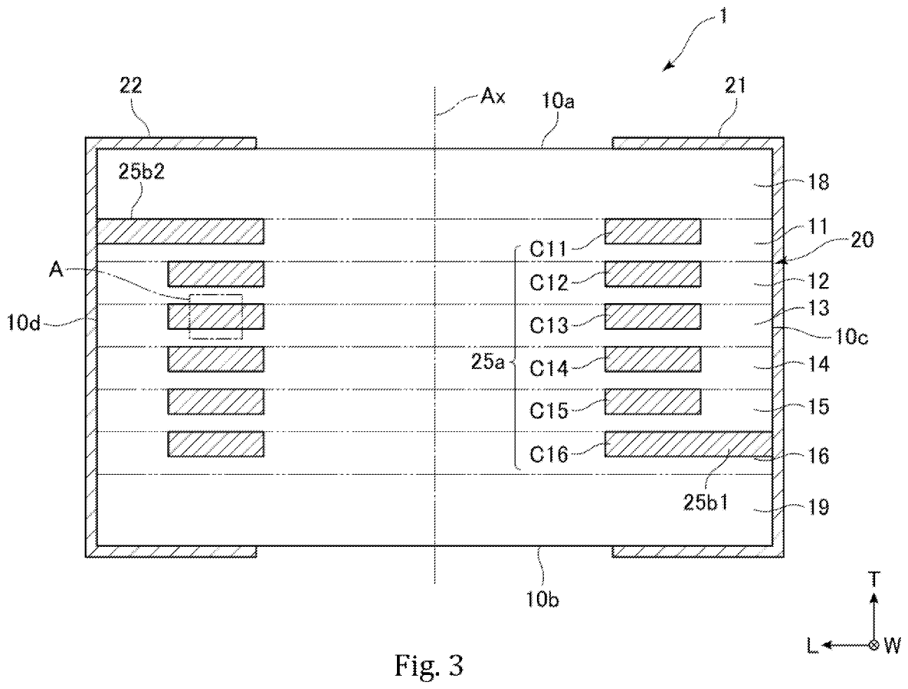

As shown in FIGS. 2 and 3, the base body 10 includes a plurality of magnetic layers stacking on top of each other. As shown, the base body 10 includes a body portion 20, a top cover layer 18 provided on the top surface of the body portion 20, and a bottom cover layer 19 provided on the bottom surface of the body portion 20. The body portion 20 includes magnetic layers 11 to 16 stacked together. The base body 10 includes the bottom cover layer 19, the magnetic layer 16, the magnetic layer 15, the magnetic layer 14, the magnetic layer 13, the magnetic layer 12, the magnetic layer 11, and the top cover layer 18 that are stacked in this order from the negative side to the positive side in the T axis direction.

The top cover layer 18 includes four magnetic layers 18a to 18d. The top cover layer 18 includes the magnetic layer 18a, the magnetic layer 18b, the magnetic layer 18c, and the magnetic layer 18d that are stacked in this order from the bottom to the top in FIG. 2.

The bottom cover layer 19 includes four magnetic layers 19a to 19d. The bottom cover layer 19 includes the magnetic layer 19a, the magnetic layer 19b, the magnetic layer 19c, and the magnetic layer 19d that are stacked in this order from the top to the bottom in FIG. 2.

The coil component 1 can include any number of magnetic layers as necessary in addition to the magnetic layers 11 to 16, the magnetic layers 18a to 18d, and the magnetic layers 19a to 19d. Some of the magnetic layers 11 to 16, the magnetic layers 18a to 18d, and the magnetic layers 19a to 19d can be omitted as appropriate. Although the boundaries between the magnetic layers are shown in FIG. 3, the boundaries between the magnetic layers may not be visible in the base body of the actual coil component to which the invention is applied.

Each of the conductor patterns C11 to C16 is electrically connected to the respective adjacent conductor patterns through the vias V1 to V5. The conductor patterns C11 to C16 connected in this manner form a spiral winding portion 25a. In other words, the winding portion 25a of the coil conductor 25 includes the conductor patterns C11 to C16 and the vias V1 to V5.

The magnetic layers 11 to 16 have the conductor patterns C11 to C16 formed thereon, respectively. The conductor patterns C11 to C16 constitute the winding portion 25a. The conductor patterns C11 to C16 extend around the coil axis Ax. In the embodiment shown, the coil axis Ax extends in the T axis direction, which is the same as the direction in which the magnetic layers 11 to 16 are stacked on each other. The coil axis Ax extends in the T axis direction. For example, the coil axis Ax passes through the intersection of the diagonal lines of the first principal surface 10a, which is rectangularly shaped as seen from above, and extends perpendicularly to the first principal surface 10a.

The end of the conductor pattern C11 opposite to the end connected to the via V1 is connected to the external electrode 22 via a lead-out conductor 25b2. The end of the conductor pattern C16 opposite to the end connected to the via V5 is connected to the external electrode 21 via a lead-out conductor 25b1. As mentioned, the coil conductor 25 include the winding portion 25a, the lead-out conductor 25b1 and the lead-out conductor 25b2.

The conductor patterns C11 to C16 are each formed on a corresponding one of the magnetic layers 11 to 16. The conductor patterns C11 to C16 are formed by applying a conductive paste onto a magnetic sheet such that the shapes of the conductor patterns C11 to C16 are formed thereon as described later, and heating the conductive paste on the magnetic sheet. The magnetic layers 11 to 15 respectively have vias V1 to V5 formed therein at a predetermined position. The vias V1 to V5 are formed by forming a through-hole at the predetermined position in the magnetic layers 11 to 15 so as to extend through the magnetic layers 11 to 15 in the T axis direction and filling the through-holes with a conductive material. The conductor patterns C11 to C16 and the vias V1 to V5 are composed mainly of copper.

As described above, the coil conductor 25 has the winding portion 25a extending around the coil axis Ax and is disposed in the base body 10. In the coil conductor 25, the end portions of the lead-out conductor 25b1 and the lead-out conductor 25b2 are exposed from the base body 10 to the outside, but the rest of the coil conductor 25 is disposed inside the base body 10. As mentioned, the coil conductor 25 includes the winding portion 25a, the lead-out conductor 25b1 and the lead-out conductor 25b2. The main component of the coil conductor 25 is copper. The coil conductor 25 contains sintered copper. The entire surface of the coil conductor 25 is covered with a copper oxide film 60 (described later). The entire surface of the coil conductor 25 refers to the surface of the coil conductor 25 other than connection surface with the external electrode 21 and the connection surface with the external electrode 22.

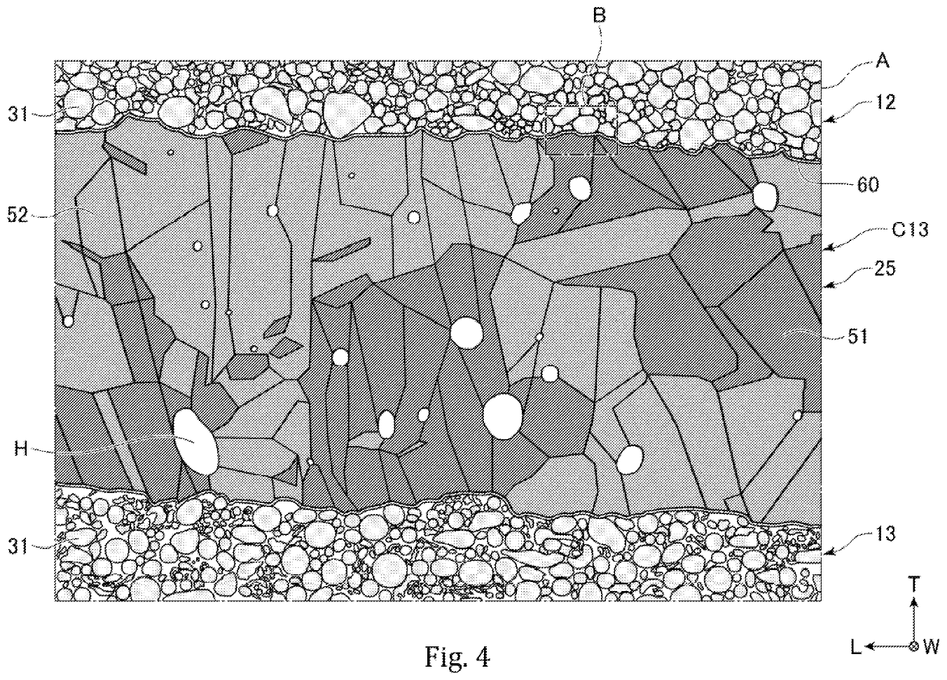

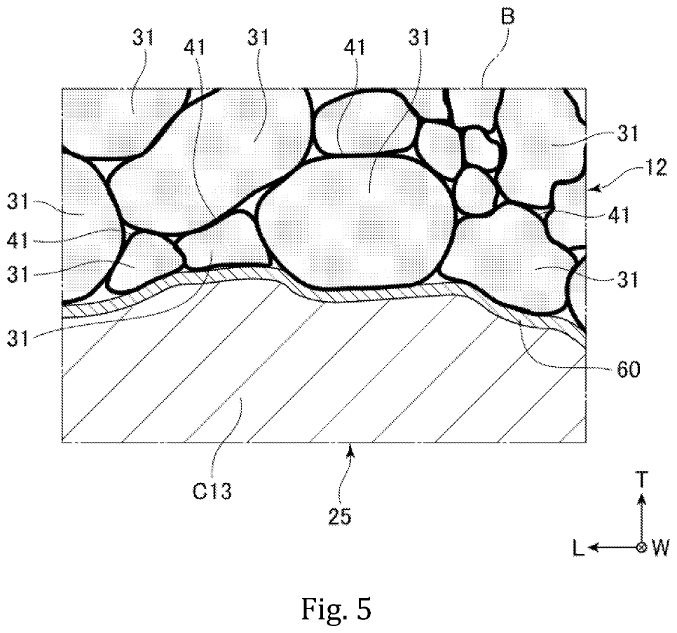

The following now describes the microstructure of the base body 10 and the coil conductor 25 with reference to FIGS. 4 and 5. FIG. 4 is an enlarged schematic sectional view of the region A shown in FIG. 3, and FIG. 5 is an enlarged schematic sectional view of the region B shown in FIG. 4. The region A is a partial region of the section of the base body 10 cut along the T-axis. The region A occupies a part of the section of the base body 10 cut along the T-axis and extends from the conductor pattern C13 to the magnetic layer 12 and the magnetic layer 13. Since FIGS. 4 and 5 illustrate the region including the conductor pattern C13 of the coil conductor 25, and therefore, the following description made with reference to FIGS. 4 and 5 refers mainly to the conductor pattern C13. The description of the conductor pattern C13 also applies to other conductor patterns (the conductor patterns C11 to C12 and C14 to C16) that constitute the coil conductor 25.

As shown in FIG. 4, the magnetic layer 12 and the magnetic layer 13 contain a plurality of metal magnetic particles 31. The magnetic layer 12 and the magnetic layer 13 may contain two or more types of metal magnetic particles. The average particle size of the metal magnetic particles 31 is, for example, 1 μm to 10 μm. The average particle size of the metal magnetic particles 31 can be defined as the average particle size (median diameter (D50)) calculated from the volume-based particle size distribution. The description of the magnetic layer 12 and the magnetic layer 13 also applies to regions of the base body 10 other than the magnetic layer 12 and the magnetic layer 13.

The metal magnetic particles 31 contained in the base body 10 may be Fe-based metal magnetic particles made of a Fe-based soft magnetic material. For example, the metal magnetic particles 31 contain Si and an element A (the element A is at least one selected from the group consisting of Cr and Al), in addition to Fe. When the metal magnetic particles 31 contain Fe, Si, Cr, and Al, the content ratio of these elements is 93 to 97 wt % for Fe, 2.5 to 6.5 wt % for Si, 0 to 2 wt % for Cr, and 0 to 3 wt % for Al, totaling 100 wt %.

The metal magnetic particles contained in the base body 10 have an insulating oxide film formed on the surface thereof. The insulating oxide film contains an oxide of one or more metal elements contained in the metal magnetic particles. As shown in FIG. 5, the surface of the metal magnetic particles 31 is coated with the oxide film 41. The metal magnetic particles 31 having the oxide films 41 formed thereon can be obtained by heat-treating a raw material powder (soft magnetic metal powder) to oxidize the elements contained in the raw material powder. As shown in FIG. 5, the oxide film 41 is provided on the surfaces of the metal magnetic particles 31. Adjacent metal magnetic particles 31 are bonded to each other via the oxide films 41.

The oxide film 41 on the surface of the metal magnetic particles 31 contained in the base body 10 contains oxides of Fe and the element A. For example, when the metal magnetic particles 31 are formed of an Fe—Cr—Si based alloy, the oxide film 41 on the surface of the metal magnetic particles 31 contains oxides of Fe, Cr, and Si. For example, when the metal magnetic particles are formed of an Fe—Al—Si based alloy, the oxide film 41 on the surface of the metal magnetic particles 31 contains oxides of Fe, Al, and Si. For example, when the metal magnetic particles 31 are formed of an Fe—Cr—Al—Si based alloy, the oxide film 41 on the surface of the metal magnetic particles 31 contains oxides of Fe, Cr, Al, and Si. The sum of the atomic percentage of Si and the atomic percentage of element A in the oxide film 41 on the surfaces of the metal magnetic particles 31 is higher than the atomic percentage of Fe in the oxide film 41. For example, when the oxide film 41 contains Fe, Cr, and Si, that is, when the oxide film 41 contains Si and Cr as the element A, the sum of the atomic percentage of Si and the atomic percentage of Cr in the oxide film 41 is higher than the atomic percentage of Fe. Thus, in the oxide film 41, the atomic percentage of Cr may be lower than that of Fe, but even in that case, the sum of the atomic percentage of Cr and the atomic percentage of Si is higher than the atomic percentage of Fe. For example, when the oxide film 41 contains Fe, Al, and Si, that is, when the oxide film 41 contains Al as the element A, the atomic percentage of Al in the oxide film 41 may be lower than that of Fe, but even in that case, the sum of the atomic percentage of Al and the atomic percentage of Si is higher than the atomic percentage of Fe. For example, when the oxide film 41 contains Fe, Cr, Al, and Si (that is, when the oxide film 41 contains Cr and Al as the element A), the atomic percentage of Cr or the atomic percentage of Al in the oxide film 41 may be lower than that of Fe, but even in that case, the sum of the atomic percentage of Cr, the atomic percentage of Al, and the atomic percentage of Si is higher than the atomic percentage of Fe. The atomic percentages of Fe, Si, and the element A in the oxide film can be calculated as follows. The point analysis is performed on five or more points, or more preferably, ten or more points in the oxide film by STEM-EDX or the like to measure the atomic percentages of Fe, Si, and the element A at each point, and the atomic percentages measured at each point are averaged. The atomic percentage of each element may be measured by, for example, EDS (energy dispersive X-ray spectroscopy) analysis.

As shown in FIG. 4, a copper oxide film 60 composed mainly of copper oxide (CuO) is provided between the conductor pattern C13 and the magnetic layer 12 and between the conductor pattern C13 and the magnetic layer 13. Similarly, the copper oxide film 60 is also provided on the surfaces of other conductor patterns constituting the coil conductor 25. The copper oxide film 60 is in contact with the metal magnetic particles 31 via the oxide films 41. As will be described later, the copper oxide film 60 results from oxidation of copper contained in the coil conductor 25.

As illustrated, the copper oxide film 60 may cover the entire surface of the conductor pattern C13. For example, the oxide layer 60 can be deemed to cover the entire surface of the conductor pattern C13 in the following manner. The base body 10 is cut along the T-axis to expose a section at three (or five) sites evenly spaced away from each other in the L-axis direction, and the exposed sections are image-captured using the SEM technique at a 5000-fold magnification such that the obtained SEM photographs can include part of the surface of the conductor pattern C13 and the base body 10. If the entire surface of the conductor pattern C13 is covered with the copper oxide film 60 in every one of the SEM photographs, the copper oxide film 60 can be deemed to cover the entire surface of the conductor pattern C13. The entire surface of the coil conductor 25 other than the connection surfaces with the external electrodes 21, 22 may be covered by the copper oxide film 60. Since the entire surface of the coil conductor 25 (the entire surface of the coil conductor 25 other than the connection surfaces with the external electrodes 21, 22) is covered by the copper oxide film 60, migration of metal copper can be inhibited. In addition, since the entire surface of the coil conductor 25 is covered by the copper oxide film 60, it is possible to prevent direct contact between the metal copper inside the coil conductor 25 and the metal magnetic particles 31.

The thickness of the copper oxide film 60 is smaller than the thickness of the conductor pattern C13. The thickness of the copper oxide film 60 refers to the dimension of the copper oxide film 60 in the T-axis direction. As illustrated, the thickness of the copper oxide film 60 may not be uniform due to the presence of irregularities in the surface of the copper oxide film 60. In this case, the thickness of the copper oxide film 60 can be determined as follows. The base body 10 is cut along the T-axis to expose a section, and the dimension of the copper oxide film 60 along the T-axis is measured at each of ten points located at equal intervals in the L-axis direction. The average of the dimensions measured at these ten points can be taken as the thickness of the copper oxide film 60. Similar to the thickness of the copper oxide film 60, the thickness of the conductor pattern C13 refers to the dimension of the conductor pattern C13 in the T-axis direction, and the average of the dimensions of the conductor pattern C13 measured at each of ten points located at equal intervals in the L-axis direction can be taken as the thickness of the conductor pattern C13.

In one aspect of the present invention, the thickness of the conductor pattern C13 is 90% or more of the sum of the thickness of the conductor pattern C13 and the thickness of the copper oxide film 60. In one aspect of the present invention, the conductor pattern C13 has a thickness of 5 μm to 100 μm. In one aspect of the present invention, the copper oxide film 60 has a thickness of 0.01 μm to 5 μm. The copper oxide film 60 is formed by oxidation of the copper powder contained in the conductive paste for forming the coil conductor 25. Therefore, when the copper oxide film 60 has a smaller thickness, the conductor pattern C13 having electrical conductivity can have a larger sectional area, and thus it is possible to inhibit reduction of electrical conductivity of the conductor pattern C13 caused by the presence of the copper oxide film 60. In addition, since the thickness of the copper oxide film 60 is 0.01 μm or larger, it is possible to inhibit ionization of the copper contained in the coil conductor 25 and prevent migration of the metal copper. Further, it is possible to ensure insulation between the conductor pattern C13 and the metal magnetic particles contained in the base body 10. The description of the thickness of the conductor pattern C13 also applies to those of other conductor patterns that constitute the coil conductor 25.

As will be described later, the conductor pattern C13 is formed by heating a conductive paste made of copper powder dispersed in an acrylic resin, which is a thermally decomposable resin. In this specification, a thermally decomposable resin refers to a resin that decomposes without combustion reaction with oxygen, and that thermally decomposes without leaving residues when heated in a nitrogen atmosphere. The absence of residues means that 99% by weight of the resin is gasified by the thermal decomposition. This can be measured using a thermogravimetric differential thermal analyzer (TG-DTA) in a nitrogen atmosphere at a temperature increase rate of 3° C./min. Therefore, the conductor pattern C13 is a dense sintered body of copper crystals. Conventionally, cellulose-based resins are used as the binder resins for the conductive paste. To completely decompose cellulose-based resins, combustion with oxygen is necessary. When a cellulose-based resin is used as a binder resin for conductive paste, thermal decomposition alone will produce residues, which will prevent the growth of the dense sintered body of copper crystals. As shown in FIG. 4, the conductor pattern C13 may contain copper crystals 51 and copper crystals 52 that have different crystal orientations. The boundary between the copper crystals 51 and the copper crystals 52 can be observed by cutting the base body 10 along the T-axis to expose a section and then capturing a reflected electron image of the section using the scanning electron microscope (SEM). In the reflected electron image, the boundary between the copper crystals 51 and the copper crystals 52, which have different crystal orientations, appears as a difference in contrast caused by the different crystal orientations. The crystal orientations and grain size of the copper crystals contained in the conductor pattern C13 can be analyzed by EBSD analysis using a field emission scanning microscope.

The conductor pattern C13 may contain voids H formed between the copper crystals. When the conductive paste is heated, the acrylic resin is thermally decomposed, and some of the regions occupied by the acrylic resin are not filled with the grown copper crystals and remain as the voids H in the conductor pattern C13 after heating. The voids H may be closed apertures encircled by copper crystals.

In an aspect of the present invention, the occupancy, which indicates the proportion of copper crystals within a predetermined region in the conductor pattern C13, is 85 vol % or more. In the observation field within the section of the base body 10, the occupancy of the copper crystals may refer to the proportion of the area of the copper crystals in the conductor pattern C13. By increasing the occupancy of the copper crystals in the conductor pattern C13, the electrical conductivity of the conductor pattern C13 can be increased.

In one aspect of the present invention, the average particle size of the copper crystals in the conductor pattern C13 is one-fifth or more of the thickness (the dimension in the T-axis direction) of the conductor pattern C13. The average particle size of the copper crystals can be measured by the ordinary methods used by those skilled in the art, such as the intercept method. More specifically, the base body 10 is cut along the T axis to expose a section, and the section is observed under SEM. In an observation image thus obtained, multiple straight lines with a predetermined length are drawn in parallel to each other. The average length of the line segments crossing the copper crystal particles can be taken as the average particle size of the copper crystals. As the average particle size of the copper crystals in the conductor pattern C13 is larger, the conductor pattern C13 can have a higher electrical conductivity.

Since the coil conductor 25 in the coil component 1 is composed mainly of copper, and its surface is covered with the copper oxide film 60, the coil conductor 25 can have excellent characteristics without no glass or resin layer on the surface thereof. First, copper is less prone to ion migration than silver, which is widely used as a material for coil conductors. In addition, since the surface of the coil conductor 25 is covered with the copper oxide film 60, contact between the coil conductor 25 and moisture present in the service environment is inhibited. Thus, ionization of the copper contained in the coil conductor 25 is inhibited. This further inhibits ion migration between the coil conductor 25 and other conductors (e.g., external conductors 21, 22). Further, since the copper oxide film 60 prevents the coil conductor 25 from being exposed to the air, the oxidation of the copper contained in the coil conductor 25 is inhibited, and thus the increase in DC resistance of the coil conductor 25 is inhibited. Further, since the copper oxide film 60 has a high specific resistance, a short circuit can be inhibited from occurring between the coil conductor 25 and the metal magnetic particles 31, and thus the dielectric withstanding voltage of the coil component 1 can be increased.

The copper oxide film 60 is formed on the surface of the coil conductor by oxidation of the copper powder contained in the conductive paste, which is the precursor of the coil conductor, during the heat treatment in the manufacturing process of the coil component. Thus, in the manufacturing process of the coil component having a coil conductor composed mainly of copper, heat treatment is essential for degreasing the conductive paste, which is the precursor of the coil conductor 25, and for sintering the copper crystals. Since the copper oxide film 60 is formed during the heat treatment which is essential in the manufacturing process of the coil component 1, it is possible to form the copper oxide film 60 without adding a new step for forming the copper oxide film 60 to the manufacturing process of the coil component 1. Since silver, which is widely used as a material for conventional coil components, has a weak bond with oxygen, it is difficult to form stable silver oxide on the surface of the coil conductor composed mainly of silver. Thus, since the coil conductor 25 is composed mainly of copper, it is possible to form the copper oxide film 60 on the surface of the coil conductor 25 without adding a new step to the manufacturing process of the coil component 1. The copper oxide film 60 serves to inhibit ion migration, inhibit oxidation of copper in the coil conductor 25, and improve dielectric withstanding voltage.

The base body 10 contains a plurality of metal magnetic particles 31, and the surface of each of the metal magnetic particles 31 is coated with the oxide film 41. The oxide film 41 contains the oxide of Fe, the oxide of Si, and the oxide of the element A (at least one element selected from the group consisting of Cr and Al). Of the members of the element A, Cr and Al have lower ionization energies than copper. Therefore, even when the coil component 1 is placed in an environment where ionization of metals is likely to occur (e.g., a hot and humid environment), Cr and Al in the oxide film 41 around the coil conductor 25 are ionized prior to copper contained in the coil conductor 25, thereby inhibiting ionization of copper contained in the coil conductor 25. This further inhibits ion migration between the coil conductor 25 and other conductors.

The oxides of Cr, Si, and Al are all highly stable, and thus oxygen is less likely to be supplied from these oxides to copper contained in the coil conductor. In addition, the oxides of Cr, Si, and Al have excellent insulating properties. In the oxide film, the oxide of Fe may be present as magnetite (Fe₃O₄) or hematite (Fe₂O₃). Since the specific resistance of magnetite is lower than that of hematite or the oxides of Cr, Si, or Al, a higher content of magnetite causes reduction of the insulation withstanding voltage of the coil component. In addition, the bond between Fe and O in hematite is weaker than the bond between Fe and O in magnetite, oxygen can be easily supplied to copper in the coil conductor. Therefore, when the proportion of Fe oxide becomes higher in the oxide films 41 covering the surfaces of the metal magnetic particles 31, it is unfavorably possible that the dielectric withstanding voltage degrades or oxidation of copper in the coil conductor progresses. In one aspect of the present invention, in the oxide films 41 covering the surfaces of the metal magnetic particles 31, the sum of the atomic percentage of Si and the atomic percentage of the element A is higher than the atomic percentage of Fe, and thus it is possible to inhibit reduction of dielectric withstanding voltage caused by hematite and oxidation of copper caused by supply of oxygen from magnetite. Thus, in one aspect of the present invention, the sum of the atomic percentage of Si and the atomic percentage of the element A is higher than the atomic percentage of Fe in the oxide films 41, it is possible to inhibit deterioration of the insulation withstanding voltage of the coil component 1 and inhibit ion migration between the coil conductor 25 and the external electrodes 21, 22 and the progress of the oxidation of copper in the coil conductor 25.

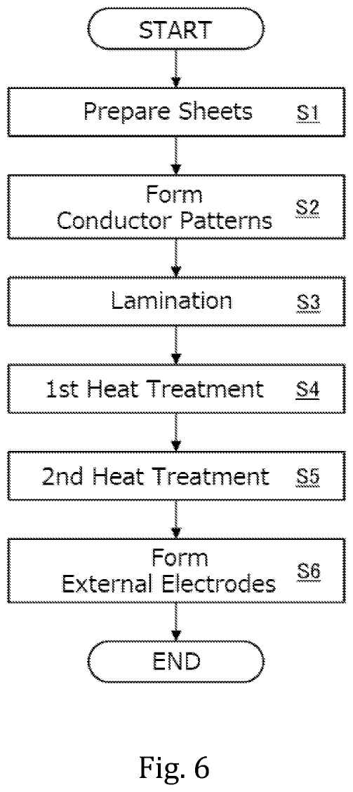

Next, one example of a manufacturing method of the coil component 1 will be described with reference to FIG. 6. FIG. 6 is a flowchart showing a manufacturing method of the coil component 1 according to one embodiment of the present invention. In the following, it is assumed that the coil component 1 is manufactured by the sheet lamination method. The coil component 1 may also be manufactured by any known methods other than the sheet lamination method. For example, the coil component 1 may be manufactured by a printing lamination method, a thin-film process method, or a slurry build method.

In the first step S1, magnetic sheets are fabricated. The magnetic sheets are produced from a magnetic material paste which is obtained by mixing and kneading soft magnetic metal powder, which is the raw material of the metal magnetic particles 31, with a binder resin and a solvent. The soft magnetic metal powder contains Fe and the element A. The binder resin for the magnetic material paste is, for example, an acrylic resin. The binder resin for the magnetic material paste may be epoxy resins, polyimide resins, resins known as binder resins other than those mentioned above, or mixtures thereof. One example of the solvent is toluene. The magnetic material paste is applied to the surface of a plastic base film by the doctor blade method or other common methods. The magnetic material paste applied to the surface of the base film is dried to obtain sheet-shaped molded bodies. A molding pressure of approximately 10 Mpa to 100 Mpa is applied to the sheet-shaped molded bodies in the mold, so that a plurality of magnetic sheets are obtained.

Next, in step S2, a conductive paste is applied to some of the plurality of magnetic sheets prepared in step S1. Thus, unfired conductor patterns to be the conductor patterns C11 to C16 after firing are formed on the associated magnetic sheets. Through holes penetrating in the lamination direction may be formed in each of the magnetic sheets. When the conductive paste is applied to the magnetic sheets, the conductive paste is filled into the through holes, and unfired vias to be the vias V1 to V5 after firing are formed. The conductive paste is applied to the magnetic sheets by, for example, screen printing.

In one aspect of the invention, the conductive paste is produced by mixing and kneading copper powder with an acrylic resin, which is a thermally decomposable resin, and a solvent. The resin used as the conductive paste is a thermally decomposable resin that does not decompose by combustion in the heat treatment in steps S4 and S5 described later. Those resins that decompose by combustion tend to leave residues between copper particles after the combustion, which can interfere with dense sintering of copper, whereas use of a thermally decomposable resin that does not decompose by combustion results in no residues between copper particles after the combustion. The average particle size of the copper particles is, for example, 0.5 μm. The copper powder is mixed into the conductive paste at a proportion of 90 wt % or more. Since the proportion of the copper powder in the conductive pate is 90 wt % or more, the conductivity of the coil conductor 25 can be higher in the finished coil component 1.

Examples of the acrylic resin for the conductive paste include (meth)acrylic acid copolymers, (meth)acrylic acid-(meth)acrylic ester copolymers, styrene-(meth)acrylic acid copolymers, or styrene-(meth)acrylic acid-(meth)acrylic ester copolymers. The solvent may be toluene, ethanol, turpineol, or mixtures of these. The conductive paste may contain modifiers for adjusting thixotropy.

Next, in step S3, the magnetic sheets prepared in step S1 are stacked together to form a top laminate to be the top cover layer 18, an intermediate laminate, and a bottom laminate to be the bottom cover layer 19. The top laminate and the bottom laminate are each formed by stacking four magnetic sheets prepared in step S1 and having no unfired conductor pattern formed thereon. The four magnetic sheets of the top laminate will be the magnetic layers 18a to 18d respectively in the finished coil component 1, and the four magnetic sheets of the bottom laminate will be the magnetic layers 19a to 19d respectively in the finished coil component 1. The intermediate laminate is formed by stacking six magnetic sheets each having an unfired conductor pattern formed thereon in a predetermined order. The six magnetic sheets of the intermediate laminate will be the magnetic layers 11 to 16 respectively in the finished coil component 1. The intermediate laminate formed in the above-described manner is sandwiched between the top laminate on the top side and the bottom laminate on the bottom side, and the top laminate and the bottom laminate are bonded to the intermediate laminate by thermal compression to obtain a body laminate. Next, the body laminate is diced to a desired size by using a cutter such as a dicing machine or a laser processing machine to make a chip laminate. The chip laminate is an example of a molded body that includes a substrate body to be the base body 10 after the heat treatment and unfired conductor patterns to be the coil conductor 25 after the heat treatment. The molded body that includes the substrate body to be the base body 10 after the heat treatment and the unfired conductor patterns to be the coil conductor 25 after the heat treatment may be fabricated by a method other than the sheet lamination method.

Next, in step S4, the chip laminate fabricated in step S3 is subjected to first heat treatment. The first heat treatment is performed in a low-oxygen atmosphere having a lower oxygen concentration than the air. The first heat treatment is performed, for example, in a low-oxygen atmosphere having an oxygen concentration of 1000 ppm to 9000 ppm. The first heat treatment is performed at a first temperature for a first heating time (e.g., four hours). The first temperature is higher than the thermal decomposition starting temperature of the acrylic resin contained in the conductive paste.

Although the decomposition temperature of acrylic resins varies depending on the type and degree of polymerization, thermal decomposition generally starts at 295° C. For this reason, the first temperature can be 295° C. or higher, e.g., 300° C. The first temperature can be higher than the thermal decomposition starting temperature of the acrylic resin by 20° C. or less, or preferably by 10° C. or less. When the thermal decomposition starting temperature of the acrylic resin is 295° C., the first temperature may be between 295° C. and 315° C., or preferably between 295° C. and 305° C. The thermal decomposition starting temperature of the acrylic resin can be measured using a commercially available thermogravimetric differential thermal analyzer (TG-DTA) in a nitrogen atmosphere at a temperature increase rate of 3° C./min. In this measurement, the temperature at which the weight loss rate is 5% can be taken as the thermal decomposition starting temperature.

As described above, during the first heat treatment in step S4, the acrylic resin contained in the unfired conductor patterns is thermally decomposed. In other words, the unfired conductor patterns are degreased. As mentioned above, the binder resin in the magnetic sheets can also be an acrylic resin. When the binder resin in the magnetic sheets is of the same type as the acrylic resin in the unfired conductor patterns, the magnetic sheets stacked together are also degreased in step S4.

In step S4, of the copper powder contained in the unfired conductor patterns, the copper powder near the surfaces of the unfired conductor patterns is oxidized. Thus, a copper oxide film is formed on the surfaces of the unfired conductor patterns. This copper oxide film will be the copper oxide film 60 in the coil component 1. The first heat treatment is performed in a low-oxygen atmosphere having an oxygen concentration of 1000 ppm to 9000 ppm. Therefore, of the copper powder contained in the unfired conductor patterns, only the copper powder near the surfaces of the unfired conductor patterns is oxidized.

In the first heat treatment in step S4, the heating temperature is slightly higher (by 10° C. to 20° C.) than the thermal decomposition starting temperature of the acrylic resin (in the above example, 295° C. to 315° C.). Since the first heating temperature in the first heat treatment is slightly higher than the thermal decomposition starting temperature of the acrylic resin, excessive oxidation of the copper powder contained in the unfired conductor patterns is prevented, and thus, of the copper powder contained in the unfired conductor patterns, only the copper powder near the surfaces of the unfired conductor patterns is oxidized. Therefore, the copper oxide film formed in the first heat treatment is a thin film. The thickness of the copper oxide film formed by the first heat treatment is, for example, 0.01 μm to 5 μm.

In step S4, the soft magnetic metal powder contained in the magnetic material paste is also oxidized, and an oxide film is formed on the surfaces of the soft magnetic metal powder. As already mentioned, the soft magnetic metal powder contains Fe, Si and the element A (at least one element selected from the group consisting of Cr and Al). Thus, the oxide film formed on the surfaces of the soft magnetic metal powder contains the oxide of Fe, the oxide of Si, and the oxide of element A. Since the first heat treatment is performed in a low-oxygen atmosphere having an oxygen concentration of 1000 ppm to 9000 ppm, of the elements contained in the soft magnetic metal powder, the oxide of Si, the oxide of Cr, and the oxide of Al are energetically more stable than the oxide of Fe, so Si, Cr, and Al are selectively oxidized rather than Fe. After most of the Si, Cr, and Al are bound to oxygen, the oxidation of Fe proceeds. Therefore, in the oxide film formed on the surfaces of the soft magnetic metal powder, the sum of the atomic percentage of Si and the atomic percentage of element A is higher than the atomic percentage of Fe. In one aspect, the soft magnetic metal powder contains Si and at least one of Cr or Al. This ensures that, in the oxide film covering the surfaces of the soft magnetic metal powder, the sum of the atomic percentage of Si and the atomic percentage of the element A is higher than the atomic percentage of Fe. The oxide film formed on the surfaces of the soft magnetic metal powder will be the oxide film 41 covering the surfaces of the metal magnetic particles 31 in the finished coil component 1.

The first heating time in step S4 may be long enough for the acrylic resin contained in the conductive paste to decompose, and it may be from 0.5 to 8 hours, for example, depending on the oxygen concentration during heating. Since the acrylic resin is also thermally decomposed in the second heat treatment in step S5, it is not necessary that the entire acrylic resin is thermally decomposed in the first heat treatment in step S4. The minimum heating time in the first heat treatment may be four hours, for example, so that after the first heat treatment, less than 20% of the acrylic resin present before the first heat treatment is yet to be decomposed or being decomposed. If heating is performed for an excessively long time in the first heat treatment, the formation of the oxide films on the surfaces of the soft magnetic metal powder progresses, and the thickness of the oxide films increases unfavorably. Conversely, if heating is performed for a shorter time than required, the formation of the oxide films on the surfaces of the soft magnetic metal powder does not progress, and the required thickness of the oxide films cannot be obtained. The increase in the thickness of the oxide films is undesirable because it results in a reduced magnetic permeability. If a minimum required thickness of the oxide films is not obtained, insulation resistance undesirably fails to be ensured. If heating is performed for an excessively long time in the first heat treatment, the formation of the copper oxide films progresses excessively due to oxidation of the copper powder in an inside of the unfired conductor patterns in addition to the copper powder near the surfaces of the unfired conductor patterns, and the thickness of the copper oxide films increases unfavorably. A larger thickness of the copper oxide films is undesirable because it reduces the proportion of metallic copper in the coil conductor 25 and thus increases conductor resistance. The first heating time in step S4 may be determined according to the oxygen concentration of the treatment atmosphere, as long as the minimum required time for thermal decomposition of the acrylic binder to progress is ensured.

Next, in step S5, the second heat treatment is performed. The second heat treatment is performed at a second temperature in a non-oxygen atmosphere, for example, a nitrogen atmosphere having an oxygen concentration of 5 ppm or less. The second temperature is higher than the thermal decomposition ending temperature of the acrylic resin contained in the unfired conductor patterns, and is high enough for the growth of copper crystal grains and the growth of the oxide films on the surfaces of the soft magnetic metal powder by thermal diffusion. The second temperature may be from 600° C. to 900° C. The second temperature is 600° C. or higher, thereby allowing growth of copper crystal grains and reducing the resistance of the coil conductor. At temperatures above 900° C., particles of soft magnetic metal powder sinter and neck together, making it impossible to obtain a magnetic base body having excellent electrical insulation properties. The second heat treatment is performed for a second heating time, for example, one hour. The thermal decomposition ending temperature of the acrylic resin can be measured using a commercially available thermogravimetric differential thermal analyzer (TG-DTA) in a nitrogen atmosphere at a temperature increase rate of 3° C./min. In this measurement, the temperature at which the weight loss rate is 99% or higher can be taken as the thermal decomposition ending temperature.

In the second heat treatment, the acrylic resin remaining in the unfired conductor patterns is completely thermally decomposed, and the copper powder in the unfired conductor patterns is sintered, resulting in the coil conductor 25 formed of a dense sintered body of copper crystals. If the acrylic resin remains in the unfired conductor patterns in the first heat treatment, this acrylic resin may be decomposed in the second heat treatment to form voids H in the coil conductor 25. After the second heat treatment, the coil conductor 25 does not contain carbon derived from the residue of the decomposition of the acrylic resin. The resin used as the conductive paste is a thermally decomposable resin, not necessarily an acrylic resin, that does not decompose by combustion in the heat treatment in steps S4 and S5. Those resins that decompose by combustion tend to leave residues between copper particles after the combustion, which can interfere with dense sintering of copper, whereas use of a thermally decomposable resin that does not decompose by combustion results in no residues between copper particles after the combustion. This allows copper crystals to grow unimpeded by binder residue during the second heat treatment and lowers the resistance of the coil conductor 25.

In the second heat treatment, elements are thermally diffused between oxide films covering the surfaces of the particles of the soft magnetic metal powder, causing the oxide films on adjacent particles of the soft magnetic metal powder to bond with each other. In the second heat treatment, the soft magnetic metal powder forms metal magnetic particles 31 having oxide films 41 formed on the surfaces thereof. Adjacent metal magnetic particles 31 are bonded to each other via the oxide films 41.

Thus, through the second heat treatment, the unfired conductor patterns form the coil conductor 25, and the particles of the soft magnetic metal powder in the laminates bond to each other to form the base body 10. The copper oxide film 60 is formed on the surface of the coil conductor 25. In this way, a chip laminate having the coil conductor 25 provided in the base body 10 is obtained.

Next, in step S6, the external electrode 21 and the external electrode 22 are formed on the surface of the chip laminate obtained in step S5. The external electrode 21 is connected to one end of the coil conductor 25, and the external electrode 22 is connected to the other end of the coil conductor 25. The chip laminate obtained after the second heat treatment may be impregnated with a resin before the external electrodes 21 and 22 are formed. The chip laminate is impregnated with, for example, a thermosetting resin such as an epoxy resin. This allows the resin to penetrate the gaps between the metal magnetic particles 31 in the base body 10. The resin that has penetrated into the base body 10 may be set to increase the mechanical strength of the base body 10.

The coil component 1 is obtained through the above steps.

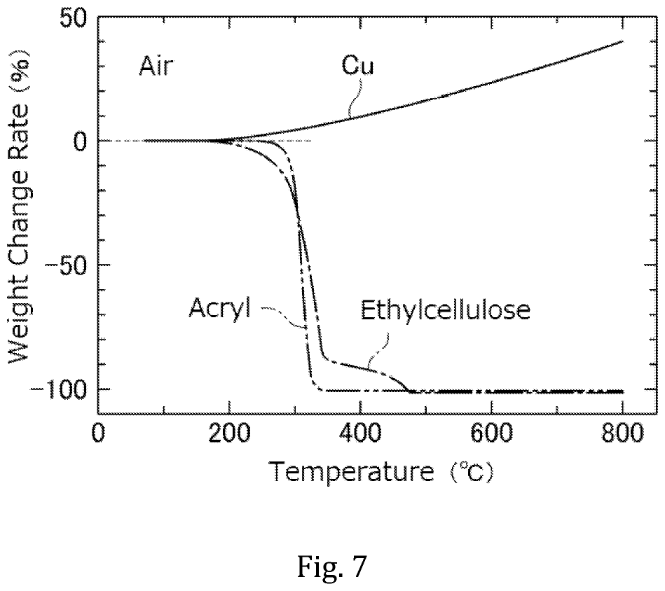

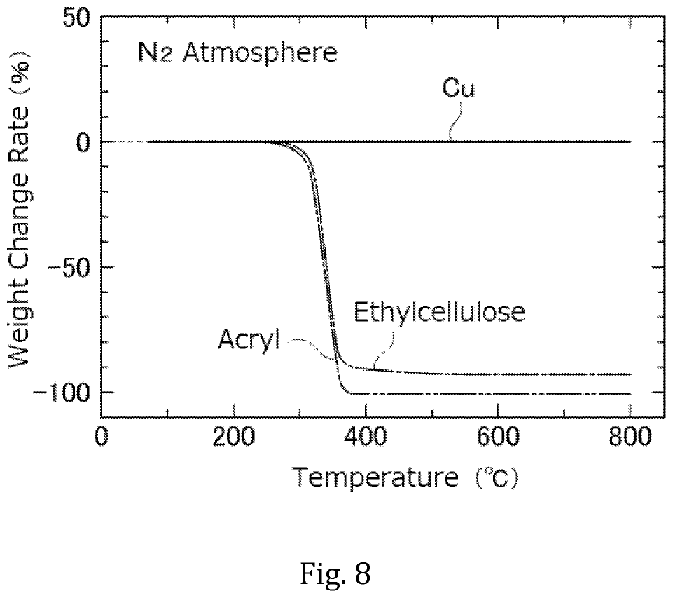

FIGS. 7 and 8 show weight change rates of acrylic resin, ethylcellulose, and copper powder measured when the temperature is increased from room temperature to 800° C. at a rate of 3° C./min using a commercially available thermogravimetric analyzer or thermogravimetric differential thermal analyzer. Ethylcellulose is a resin conventionally used for a wide range of applications as a binder for a conductive paste. As shown in FIG. 7, heating copper powder in the air increases its weight due to progression of oxidation. When the acrylic resin and ethylcellulose (ethycell) are heated in the air, the acrylic resin is completely decomposed by thermal decomposition starting at around 295° C., while ethylcellulose loses about 90% of its weight by thermal decomposition starting at around 250° C., and then loses, by combustion starting at around 350° C., its weight corresponding to the residue that was not decomposed by the thermal decomposition.

As shown in FIG. 8, heating copper powder in a nitrogen atmosphere does not increase its weight because no or almost no oxidation occurs. The acrylic resin is completely decomposed by thermal decomposition even when heated in a nitrogen atmosphere. When the acrylic resin is heated in a nitrogen atmosphere, thermal decomposition starts at around 295° C. and ends at around 380° C. with complete thermal decomposition of the acrylic resin. On the other hand, when ethylcellulose (ethycell) is heated in a nitrogen atmosphere, about 90% of ethylcellulose is decomposed by thermal decomposition starting at around 290° C., but about 10% carbonized ethylcellulose remains. Since ethylcellulose does not burn in a nitrogen atmosphere, heating ethylcellulose to 800° C. results in carbonization of about 10% of the ethylcellulose, the carbonized ethylcellulose being the residue.

From the TG curves in FIGS. 7 and 8, it can be understood that the following defects occur when a coil conductor is fabricated using a conductive paste in which copper powder is dispersed in ethylcellulose, which is widely used as a binder resin for a conductive paste. For example, heating in an oxygen atmosphere (e.g., in the air) a conductive paste with copper powder dispersed in ethylcellulose causes excessive oxidation of the copper powder, which increases cracking in the base body and thus increases the specific resistance in the coil conductor. When the conductive paste with copper powder dispersed in ethylcellulose is heated in a reducing atmosphere (e.g., a mixture of nitrogen and hydrogen), oxidation of copper does not occur, but as much as 10% of ethylcellulose remains in the conductive paste. The residue of ethylcellulose in the conductive paste inhibits the sintering of copper crystals and prevents the densification of copper crystals in the coil conductor 25. This causes the conductivity of the coil conductor to deteriorate.

By contrast, in one aspect of the present invention, an acrylic resin, which is thermally decomposable, is used as a binder resin for the conductive paste, and therefore, in the first heat treatment, the chip laminate is heated at the first temperature higher than the thermal decomposition starting temperature of the acrylic resin in a low oxygen atmosphere of 1000 ppm to 9000 ppm, such that degreasing (thermal decomposition of the acrylic resin) is possible without excessive oxidation of the copper powder. In the second heat treatment, the chip laminate is heated in a nitrogen atmosphere at the second temperature higher than the thermal decomposition ending temperature of the acrylic resin, which allows complete thermal decomposition of the acrylic resin, thereby obtaining the coil conductor 25 with densely sintered copper crystals. In addition, since the first heat treatment is performed in a low-oxygen atmosphere of 1000 ppm to 9000 ppm, the oxide film 41 can be formed on the surfaces of the metal magnetic particles 31, and the copper oxide film 60 can be formed on the surface of the coil conductor 25.

### EXAMPLES

According to steps S1 to S3 above, 800 unheated chip laminates were produced as follows. First, Fe-based soft magnetic metal powder (Fe: 95 wt %, Si: 4.5 wt %, Cr: 0.5 wt %) was mixed with an acrylic resin and toluene to produce a magnetic material paste, and the magnetic material paste was then formed into sheets to produce magnetic sheets. A conductive paste was applied to the magnetic sheets to form unfired conductor patterns that will be the conductor patterns C11 to C16. The conductive paste was produced by mixing and kneading copper powder having an average particle size of 0.5 μm with an acrylic resin and toluene. The conductive paste contained 90 wt % copper powder. Next, the magnetic sheets were stacked together to fabricate the chip laminates. The 800 chip laminates produced in this way were divided into eight groups each including 100 chip laminates, denoted by sample number 1 to sample number 8. As shown in Table 1, the 100 chip laminates of sample number 1 were subjected to the first heat treatment at 300° C. in a low-oxygen atmosphere of 900 ppm oxygen concentration. Each sample of sample numbers 2 to 8 was also subjected to the first heat treatment for four hours in an atmosphere of the oxygen concentration listed in Table 1. Each sample was heated at 300° C.

TABLE 1

| | | | | | Evaluation | |
|---|---|---|---|---|---|---|
| | 1st Heat Treatment | | 2nd Heat Treatment | | | Interlayer |
| Sample | 1st Temp. | Oxygen | 2nd Temp. | Oxygen | | Short |
| Number | (° C.) | (ppm) | (° C.) | (ppm) | Crack | Circuit |
| No. 1 | 300 | 900 | 800 | 3 | ∘ | x |
| No. 2 | 300 | 1000 | 800 | 3 | ∘ | ∘ |
| No. 3 | 300 | 2500 | 800 | 3 | ∘ | ∘ |
| No. 4 | 300 | 5000 | 800 | 3 | ∘ | ∘ |
| No. 5 | 300 | 7500 | 800 | 3 | ∘ | ∘ |
| No. 6 | 300 | 9000 | 800 | 3 | ∘ | ∘ |
| No. 7 | 300 | 10000 | 800 | 3 | Δ | ∘ |
| No. 8 | 300 | 12000 | 800 | 3 | x | ∘ |

Next, each of the chip laminates of sample numbers 1 to 8 that had undergone the first heat treatment was subjected to the second heat treatment at 800° C. for one hour in a nitrogen atmosphere having an oxygen concentration of 3 ppm.

The appearance of each of the 800 samples included in sample numbers 1 to 8 that had undergone the second heat treatment was observed under a stereomicroscope to check for cracks in the base body. For each of sample numbers 1 to 6, no cracks were observed in any of the 100 samples. For sample number 7, cracks were observed in one out of 100 samples. For sample number 8, cracks were observed in two of the 100 samples.

The inductance value at 1 MHz was measured for each of the 100 samples grouped under sample numbers 1 to 8 (800 samples in total), and the samples with a measured value equal to or less than 0.8 times the design value of inductance were evaluated as having an interlayer short circuit (a short circuit between adjacent conductor patterns). For each of sample numbers 2 to 8, occurrence of an interlayer short circuit was not confirmed in any of the 100 samples. For sample number 1, occurrence of an interlayer short circuit was observed in two of the 100 samples.

The above indicates that when the oxygen concentration in the first heat treatment was 10,000 ppm or higher, cracks occurred in the base body 10 surrounding the coil conductor 25, because the unfired conductor patterns expanded in the process of turning into the coil conductor 25 due to progression of oxidation of the copper powder in the conductive paste.

The above also indicates that when the oxygen concentration in the first heat treatment was 900 ppm or lower, the copper oxide film was not sufficiently formed on the surfaces of the unfired conductor patterns in the first heat treatment, resulting in poor insulation between adjacent conductor patterns.

Therefore, it was found that an oxygen concentration from 1000 ppm to 9000 ppm in the first heat treatment makes it possible to form the copper oxide film 60 on the surface of the coil conductor 25 without causing cracks in the base body 10.

In addition, the 100 samples of each of sample numbers 2 to 7 were tested for moisture resistance at 85° C. and 85 RH (room humidity) for 2000 hours. An electric power of 500 mW was applied to each of the tested samples. The Q value of each sample was measured before and after the moisture resistance test using the RF Impedance/Material Analyzer E4991A from Keysight Technologies to evaluate the rate of decrease in Q value. All the samples showed a good rate of decrease in Q value within 10%. On the other hand, for sample number 1, three out of the 100 samples showed a rate of decrease in Q value exceeding 10%. This indicates that when the oxygen concentration in the first heat treatment was 900 ppm or lower, the copper oxide film was not sufficiently formed on the surfaces of the unfired conductor patterns in the first heat treatment, resulting in low insulation between adjacent conductor patterns that led to high rates of decrease in Q value. For sample number 8, seven out of the 100 samples showed a rate of decrease in Q value exceeding 10%. This indicates that when the oxygen concentration in the first heat treatment was 10,000 ppm or higher, cracks occurred in the base body 10 surrounding the coil conductor 25, resulting in larger rates of decrease in Q value. Thus, an oxygen concentration of 1000 ppm to 9000 ppm in the first heat treatment made it possible to obtain a coil component having a coil conductor composed mainly of copper with no deterioration in reliability.

The dimensions, materials, and arrangements of the constituent elements described herein are not limited to those explicitly described for the embodiments, and these constituent elements can be modified to have any dimensions, materials, and arrangements within the scope of the present invention. Furthermore, constituent elements not explicitly described herein can also be added to the described embodiments, and it is also possible to omit some of the constituent elements described for the embodiments.

One or more of the steps of the manufacturing method described herein can be omitted as appropriate as long as there is no contradiction. In the manufacturing method described herein, steps not described explicitly in this specification may be performed as necessary. One or more of the steps included in the above-described manufacturing method may be performed in different orders without departing from the spirit of the invention. One or more of the steps included in the above-described manufacturing method may be performed at the same time or in parallel, if possible.

The words “first,” “second,” “third” and so on used herein are added to distinguish constituent elements but do not necessarily limit the numbers, orders, or contents of the constituent elements. The numbers added to distinguish the constituent elements should be construed in each context. The same numbers do not necessarily denote the same constituent elements among the contexts. The use of numbers to identify constituent elements does not prevent the constituent elements from performing the functions of the constituent elements identified by other numbers.

This specification also discloses the following embodiments.

[1] A coil component comprising:
a base body including a plurality of metal magnetic particles, the plurality of metal magnetic particles containing Fe, Si, and an element A, the element A being at least one selected from the group consisting of Cr and Al, a surface of each of the plurality of metal magnetic particles being covered by an oxide film containing Fe oxide and an oxide of the element A;
a coil conductor disposed in the base body and made mainly of copper; and
a copper oxide film covering a surface of the coil conductor and made mainly of copper oxide,
wherein in the oxide film covering the surface of each of the plurality of metal magnetic particles, a sum of an atomic percentage of Si and an atomic percentage of the element A is higher than an atomic percentage of Fe.
   [2] The coil component of [1], wherein a first thickness representing a thickness of the coil conductor in one axial direction is 90% or more of a second thickness representing a sum of the thickness of the coil conductor and a thickness of the copper oxide film in the one axial direction.
   [3] The coil component of [1] or [2], wherein the copper oxide film has a thickness of 0.01 μm to 5 μm.
   [4] The coil component of any one of [1] to [3], wherein the coil conductor contains voids.
   [5] The coil component of any one of [1] to [4], wherein the plurality of metal magnetic particles include a first metal magnetic particle and a second metal magnetic particle adjacent to the first metal magnetic particle, and
wherein the first metal magnetic particle and the second metal magnetic particle are bonded to each other via the oxide film covering a surface of the first metal magnetic particle and the oxide film covering a surface of the second metal magnetic particle.
   [6] The coil component of any one of [1] to [5], wherein the coil conductor contains sintered copper.
   [7] A circuit board comprising the coil component of any one of [1] to [6].
   [8] An electronic component comprising the circuit board of [7].

What is claimed is:

1. A coil component comprising:
a base body including a plurality of metal magnetic particles, the plurality of metal magnetic particles containing Fe, Si, and an element A, the element A being at least one selected from the group consisting of Cr and Al, a surface of each of the plurality of metal magnetic particles being covered by an oxide film containing Fe oxide and an oxide of the element A;
a coil conductor disposed in the base body and made mainly of copper; and
a copper oxide film covering a surface of the coil conductor and made mainly of copper oxide,
wherein in the oxide film covering the surface of each of the plurality of metal magnetic particles, a sum of an atomic percentage of Si and an atomic percentage of the element A is higher than an atomic percentage of Fe.

2. The coil component of claim 1, wherein a first thickness representing a thickness of the coil conductor in one axial direction is 90% or more of a second thickness representing a sum of the thickness of the coil conductor and a thickness of the copper oxide film in the one axial direction.

3. The coil component of claim 1, wherein the copper oxide film has a thickness of 0.01 μm to 5 μm.

4. The coil component of claim 1, wherein the coil conductor contains voids.

5. The coil component of claim 1,
wherein the plurality of metal magnetic particles include a first metal magnetic particle and a second metal magnetic particle adjacent to the first metal magnetic particle, and
wherein the first metal magnetic particle and the second metal magnetic particle are bonded to each other via the oxide film covering a surface of the first metal magnetic particle and the oxide film covering a surface of the second metal magnetic particle.

6. The coil component of claim 1, wherein the coil conductor contains sintered copper.

7. A circuit board comprising the coil component of claim 1.

8. An electronic component comprising the circuit board of claim 7.
